(19) United States
(12) Patent Application Publication
(10) Pub. No.: US 2007/0043828 A1
(43) Pub. Date: Feb. 22, 2007

(54) GHOST MESSAGING

(75) Inventors: David Famolari, Montclair, NJ (US); Michael Long, (US)

Correspondence Address: WATCHSTONE P+D, PLC, 1250 CONNECTICUT AVENUE, N.W., SUITE 700, WASHINGTON, DC, 20036-2657, US

(73) Assignees: TOSHIBA AMERICA RESEARCH, INC., Piscataway, NJ (US); TELCORDIA INC., Piscataway, NJ (US)

(21) Appl. No.: 11/161,771

(22) Filed: Aug. 16, 2005

(51) Int. Cl. G06F 15/16

(52) U.S. Cl. 709/219

(57) ABSTRACT

In some embodiments, a ghost messaging system is disclosed that includes: a server configured to store user information, location information of client devices and ghost messages composed by users of client devices; a plurality of access points configured to transmit location information related to client devices to the server; and at least one client device configured to compose ghost messages, including indications of location relevance.

### BACKGROUND

1. Field of the Invention

The present application relates to communications and messaging over computer networks. The preferred embodiments also relate more particularly to messaging systems such as Instant messaging systems, to information relevance management systems, to enterprise information delivery and notification systems, to localized wireless data broadcast systems and the like. And, preferred embodiments provide a wireless location based messaging and presence system.

2. General Background Discussion

Networks and Internet Protocol

There are many types of computer networks, with the Internet having the most notoriety. The Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

With respect to IP (Internet Protocol), this is a protocol by which data can be sent from one device (e.g., a phone, a PDA [Personal Digital Assistant], a computer, etc.) to another device on a network. There are a variety of versions of IP today, including, e.g., IPv4, IPv6, etc. Each host device on the network has at least one IP address that is its own unique identifier.

IP is a connectionless protocol. The connection between end points during a communication is not continuous. When a user sends or receives data or messages, the data or messages are divided into components known as packets. Every packet is treated as an independent unit of data.

In order to standardize the transmission between points over the Internet or the like networks, an OSI (Open Systems Interconnection) model was established. The OSI model separates the communications processes between two points in a network into seven stacked layers, with each layer adding its own set of functions. Each device handles a message so that there is a downward flow through each layer at a sending end point and an upward flow through the layers at a receiving end point. The programming and/or hardware that provides the seven layers of function is typically a combination of device operating systems, application software, TCP/IP and/or other transport and network protocols, and other software and hardware.

Wireless Networks

Wireless networks can incorporate a variety of types of mobile devices, such as, e.g., cellular and wireless telephones, PCs (personal computers), laptop computers, wearable computers, cordless phones, pagers, headsets, printers, PDAs, etc. For example, mobile devices may include digital systems to secure fast wireless transmissions of voice and/or data. Typical mobile devices include some or all of the following components: a transceiver (i.e., a transmitter and a receiver, including, e.g., a single chip transceiver with an integrated transmitter, receiver and, if desired, other functions); an antenna; a processor; one or more audio transducers (for example, a speaker or a microphone as in devices for audio communications); electromagnetic data storage (such as, e.g., ROM, RAM, digital data storage, etc., such as in devices where data processing is provided); memory; flash memory; a full chip set or integrated circuit; interfaces (such as, e.g., USB, CODEC, UART, PCM, etc.); and/or the like.

Wireless LANs (WLANs) in which a mobile user can connect to a local area network (LAN) through a wireless connection may be employed for wireless communications. Wireless communications can include, e.g., communications that propagate via electromagnetic waves, such as light, infrared, radio, microwave. There are a variety of WLAN standards that currently exist, such as, e.g., Bluetooth, IEEE 802.11, and HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together. Bluetooth devices may be named according to a common naming concept. For example, a Bluetooth device may possess a Bluetooth Device Name (BDN) or a name associated with a unique Bluetooth Device Address (BDA). Bluetooth devices may also participate in an Internet Protocol (IP) network. If a Bluetooth device functions on an IP network, it may be provided with an IP address and an IP (network) name. Thus, a Bluetooth Device configured to participate on an IP network may contain, e.g., a BDN, a BDA, an IP address and an IP name. The term “IP name” refers to a name corresponding to an IP address of an interface.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a PCMCIA card or another device: a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, Multiple Interface Devices (MIDs), 802.11x devices (IEEE 802.11 devices including, e.g., 802.11a, 802.11b and 802.11g devices), HomeRF (Home Radio Frequency) devices, Wi-Fi (Wireless Fidelity) devices, GPRS (General Packet Radio Service) devices, 3 G cellular devices, 2.5 G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, e.g., Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds means to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using, e.g., Internet Control Message Protocol (ICMP).

In basic IP routing (i.e. outside mobile IP), typically, routing mechanisms rely on the assumptions that each network node always has a constant attachment point to, e.g., the Internet and that each node's IP address identifies the network link it is attached to. In this document, the terminology “node” includes a connection point, which can include, e.g., a redistribution point or an end point for data transmissions, and which can recognize, process and/or forward communications to other nodes. For example, Internet routers can look at, e.g., an IP address prefix or the like identifying a device's network. Then, at a network level, routers can look at, e.g., a set of bits identifying a particular subnet. Then, at a subnet level, routers can look at, e.g., a set of bits identifying a particular device. With typical mobile IP communications, if a user disconnects a mobile device from, e.g., the Internet and tries to reconnect it at a new subnet, then the device has to be reconfigured with a new IP address, a proper netmask and a default router. Otherwise, routing protocols would not be able to deliver the packets properly.

Electronic Communications

A variety of electronic communication methods are known. For example, a number of common electronic communication methods include Instand Messaging and e-mail.

Instant Messaging (sometimes referred to as IM) enables users to easily see whether a chosen buddy (such as, e.g., a friend, colleague, co-worker or the like) is connected to the Internet and, if so, to exchange messages with them. Instant Messaging typically differs from common e-mail in the immediacy of the message exchange. Typically, IM exchanges are text-only. However, some services (e.g., AOL Instant Messaging) enable voice messaging and file sharing. In IM, both users need to subscribe to the service (e.g., and have certain software on their user devices), and need to be online at the same time. In addition, the intended recipient needs to be willing to accept instant messages. If one tries to send an IM to someone who is not online, or who is not willing to accept an Instant Message, a notification is typically provided that the transmission cannot be completed. If the recipient's online software is set to accept Instant Messages, it typically alerts the recipient with a distinctive sound and displays a Pop-Up window that indicates that an IM has arrived, and that enables the recipient to accept or reject it, or displays a Pop-up window containing the incoming message. In general, IM can be truly or virtually instantaneous (with, e.g., delays of usually less than a number of seconds), such that it is typically possible for two people to have a real-time online “conversation” by sending IMs to each other.

E-mail or electronic mail involves the exchange of computer-stored messages by telecommunication. E-mail messages are usually encoded in ASCII text. However, often non-text files, such as graphic images and sound files, can be transmitted as attachments (e.g., sent in binary streams). E-mail can also be exchanged between online service provider users and in networks other than the Internet (whether public or private). Typically, e-mail can be transmitted to lists of people and/or to individuals. E-mail is one of the protocols included with the Transport Control Protocol/Internet Protocol (TCP/IP) suite of protocols. A popular protocol for sending e-mail is Simple Mail Transfer Protocol. In addition, one illustrative popular protocol for receiving e-mail is POP3. A variety of computer software systems, such as, e.g., those by NETSCAPE and MICROSOFT, include an e-mail utility with their Web browser software.

While a variety of communication systems and methods are known, there remains a need for improved and enhanced systems and methods for communicating over the Internet and/or other networks. Among other things, while there has been work done in the area of physically tracking devices and people, existing systems do not allow, inter alia, messages to be directed to particular locations and not to other locations.

### SUMMARY OF THE PREFERRED EMBODIMENTS

The preferred embodiments of the present invention can significantly improve upon existing methods and/or apparatuses.

Traditional messaging systems do not allow senders to specify geographical areas where their messages are relevant, nor do they allow senders to specify time frames for which their messages are relevant. In the preferred embodiments, Ghost Messaging adds two new important degrees of freedom to messaging that address these current shortcomings—namely, location and temporal relevance. The preferred embodiments provide methods and system for directing messages to specific locations for delivery when recipients enter those locations. In the preferred embodiments, temporal relevance is also established, enabling removal of irrelevant information.

According to some of the preferred embodiments, a messaging system is provided that includes: a server configured to receive location information related to client devices from a plurality of access points; the server being configured to receive ghost composed by users of client devices that include indications of location relevance; and the server being configured to store user information data, data related to the location information of client devices and data related to the messages composed by client devices. In some preferred examples, the system is configured to require the satisfaction of the following three criteria for delivery of one of the messages: an intended recipients field must be satisfied; an intended locations field must be satisfied; and a temporal relevance field must be satisfied.

According to some other embodiments, a ghost messaging system is provided that includes: a server configured to store user information, location information of client devices and ghost messages composed by users of client devices; a plurality of access points configured to transmit location information related to client devices to the server; and at least one client device configured to compose ghost messages, including indications of location relevance. In some preferred examples, the system further includes the plurality of access points being distributed throughout a vicinity and having coverage areas demarcating locations within the vicinity. In some preferred examples, the system further includes the system being configured to associate a client device within a coverage area of one of the access points with the one of the access points. In some examples, the system is configured to associate a client device within a range of a plurality of access points with an access point to which the client device has better signal characteristics. In some other examples, the server is configured to store user buddy lists along with locations of buddies that are currently online. In some examples, the system is configured to enable the client devices to display a user buddy list that includes the presence, status and location of buddies that are currently online.

In some preferred examples, the system is further configured to enable a user to initiate a real-time chat session with at least one of the user's buddies that are currently active and available.

In some preferred examples, the system further includes the system being adapted to provide a Web-based user interface through which ghost messaging subscribers can send ghost messages.

According to some other embodiments, a method of managing distribution of an electronic message from a sender to a recipient is performed that includes: receiving an electronic message from a client device operated by a user which electronic message includes an identification of at least one location for delivery of the message; and delivering the electronic message to at least one recipient within the identified at least one location based on the identification of the at least one location. In some examples, the method further includes receiving the electronic message with an identification of a temporal relevance of the electronic message, and only delivering the electronic message to the at least one recipient within the at least one identified location during a relevant time period based on the identification of temporal relevance. In some examples, the method further includes receiving the electronic message with an identification of at least one intended recipient for delivery of the message. In some examples, the method further includes that the at least one recipient within the at least one identified location consists of at least one of the at least one intended recipient, and including only delivering the message to the at least one of the at least one intended recipient in the event that the at least one of the at least one intended recipient is within the location during the relevant time period.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by a way of example, and not limitation, in the accompanying figures, in which:

FIG. 1 is an architectural diagram showing exemplary architectural components of a ghost messaging system according to some illustrative embodiments of the invention;

FIG. 2 is an architectural diagram showing exemplary sub-components of an illustrative access point and illustrative client devices or user stations according to some illustrative embodiments of the invention;

FIG. 3(A) is an illustrative display image that can be presented to a user of a client device during the composition of a ghost message in some illustrative embodiments of the invention; and

FIG. 3(B) is an illustrative display image that can be presented to a recipient user of a client device during the viewing of a received ghost message in some illustrative embodiments of the invention.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the various inventions described herein and that such examples are not intended to limit the invention to preferred embodiments described herein and/or illustrated herein.

General

The preferred embodiments provide system and method for directing messages to specific locations for delivery when recipients enter those locations. Preferably, temporal relevance is also expressed, enabling removal of irrelevant information.

In the preferred embodiments, Ghost Messaging™ is generally akin to the Instant Messaging concept. As discussed above, Instant Messaging (IM) enables two people to engage in an online real-time chat. IM solves this problem by providing presence indications to users regarding the availability of other users in the system in which they are interested (i.e., buddies). On the other hand, Ghost Messaging addresses the inability to route messages to specific locations and, upon the arrival of an intended recipient into the specified area, deliver them instantly. Furthermore, Ghost Messaging addresses the existing inability to specify the temporal relevance of messages in the system. Among other things, this capability allows information delivery systems to prune out old and/or irrelevant messages and, thus, limit the amount of resources used to handle information that is no longer important or the like.

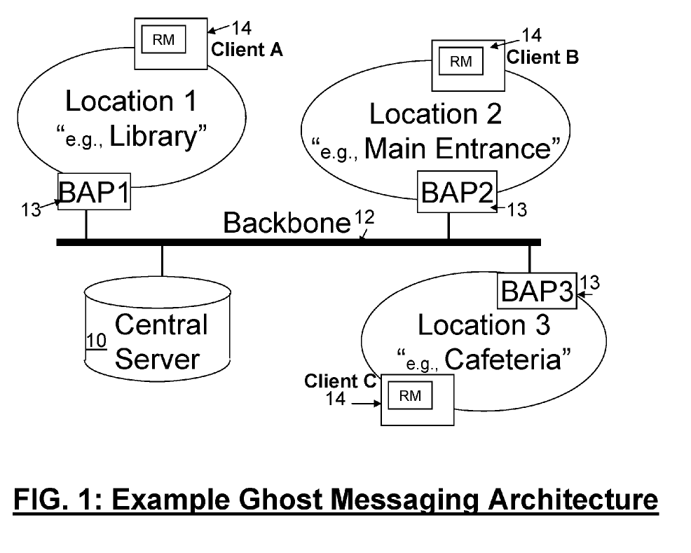

In some preferred embodiments, as shown in FIG. 1, a Ghost Messaging system is provided that employs three architectural components to deliver service. In this regard, a first preferred architectural component is a server or central server 10. Preferably, the central server 10 is attached to a backbone network 20 where Ghost Messages, user information, user status, Location mappings, etc., are preferably stored in some embodiments. Depending on circumstances, the server 10 can include a variety of architectures. For example, in some embodiments, the server 10 can include a centralized server, which can, e.g., include in some examples a single server computer in a centralized arrangement. In other embodiments, however, the server 10 can include a distributed server that may include a plurality of devices (such as, e.g., a plurality of server computers) distributed over a plurality of different locations.

A second preferred architectural component is at least one—preferably, a plurality of—Bluetooth Access Points (BAPs) 30 that are also attached to the backbone network and that are deployed throughout the service area. In the preferred embodiments, the BAPs 30 would have a limited wireless coverage area (such as, e.g., usually on the order of 30-100 feet) that demarcates a “location.” While Bluetooth Access Points (BAPs) 30 are used in some exemplary embodiments, it is contemplated that other embodiments could be built upon any other type of Access Points (AP) or devices having appropriate functionality.

A third preferred architectural component is at least one—preferably, a plurality of—client devices 40. In the preferred embodiments, the client devices 40 are adapted to run Ghost Messaging client applications (referred to herein as a ReachMe application). In the preferred embodiments, BAPs 30 detect the presence of such client devices 40 who then become associated with that location.

Preferably, the central server 10 is updated with a new user device 40 in the new area and determines if there are any Ghost Messages that are relevant for that combination of user and location. If so those messages are delivered to the client device.

There are a variety of different emodiments of this system that can be implemented. For example, different embodiments can be implemented depending upon the wireless medium used to transfer the messages; for example, in some examples, this can be either through the BAPs 30, themselves, or through an exisiting wireless IP connection.

Preferably, in addition to delivering Ghost Messages, the system will also update buddy lists of which a user of a client device 40 is a member with the user's present location (such as, e.g., Location 1, Location 2, and/or Location 3), status and signal strength in that area. In addition, users of the system are preferably enabled to establish real-time chat sessions with in addition to sending Ghost Messages for other users of the system.

In contrast to existing technologies, in the preferred embodiments, a system and method is provided in which addressable electronic information can be directed to non-specified individuals at specific locations. Current messaging systems do not provide for geographical (i.e., rather than merely logical or administrative) information to be used in addressing of messages. Common e-mail allows a sender to specify a <username>@<adminstrative_domain>, while Instant Messaging systems, such as, e.g., that of AOL and YAHOO, allow the specification of a <username> while the administrative domain is implicit by use of the AOL or YAHOO Instant Message client applications. Among other things, Ghost Messaging introduces the notion of specifiying geographical domains, as well.

Typical wireless networking solutions tend to place value on wide coverage areas. For example, typically, the more square feet that an access point can manage is considered to be the better. On the other hand, in the preferred embodiments described herein, a non-intuitive “smaller is better” approach is introduced in which value is obtained by using many small-powered or small-area Access Points to service a general area or region rather than one large Access Point. Among other things, this provides greater resolution in terms of creating finer-grained locations that can be addressed. Furthermore, providing service to only a specific subset of geographic areas (such as, e.g., a main entrance, a library, a single room, or a set of a few rooms within a building or floor, etc.) as opposed to providing blanket service to a wide area (such as, e.g., an entire enterprise, an entire campus or group of buildings, an entire building, or an entire floor of an enterprise) is a departure from the current thinking.

The possible use of uncoordinated multiple wireless interfaces to provide a coherent service, as per the preferred embodiments, is also a departure from conventional lines of thinking.

In addition, in some preferred embodiments, Ghost Messaging can use one wireless technology to provide location information while another provides information delivery.

In addition, the combination of temporal relevance and location relevance to conventional messaging systems has been outside of conventional thinking. Conventional messaging systems, such as AOL's Instant Messenger, rely on the availability of the recipient in order to work—i.e., if the reciepient is unavailable, the sender cannot send a message. The addition of message lifetimes is a novel and unique concept because traditional Instant Messaging systems rely on the fact the receipient is always available to receive a message if it has been created; therefore, traditionally, a message never has a chance to “age.”

While m-commerce advertisements have been talked about before—where users carrying properly equipped terminals passby a merchant and then receive a broadcast informing them of a current sale, etc. Typically, this has been talked about as a one-way service where there is content created by the Merchant and it is broadcast to people outside of their establishment. In some preferred embodiments, however, Ghost Messaging can provide, inter alia, a novel addition to this concept that makes it interactive and 2-way. With Ghost Messaging, the producers of those broadcast messages do not need to be limited to Merchants; for example, they can be customers offering feedback on their experiences, recommendations, etc. In some illustrative examplary applications, Ghost Messaging allows the consumer of the broadcast data to also be a producer of the content. In addition, in some embodiments, Ghost Messaging enables the identification of specific intended recipients in combination with geographical relevance.

Additionally, Ghost Messaging, in this context, can be used to achieve novel uses of wireless devices to create a “history” of electronic exchanges that have taken place at a particular location. Imagine, for example, a scenario in which two friends agree to meet each other at a movie theater. One friend arrives on time, but the other does not arrive on time and is nowhere to be found. The friend who is at the movie theater would be able to leave his tardy friend a Ghost Message that would be delivered to his friend when, and if, the friend shows up at the theater. This is generally parallel to leaving a wireless note attached to the ether of the theater. One substantial advantage, aside from this type of communication occurring in electronic form and over wireless systems, is that this note can only be read by the intended recipient. Furthermore, only the intended recipient is aware of the note. This is much different than leaving a handwritten note at a public place. There is no existing system for which, among other things, this type of communication behavior is possible.

Additionally, another advantages and novel aspect of some preferred embodiments is the use of Bluetooth Access Points (BAPs), which are typical networking devices used to exchange network information, as location beacons. Instead of making use of the BAPs in their intended manner, Ghost Messaging reprises their role and assigns them novel functionality where they provide presence indications of users in locations, as opposed to creating network connections with end devices.

Among other things, Ghost Messaging achieves some advantageous results, such as, e.g., the delivery of messages to places where they are relevant and non-delivery to places where they are irrelevant. The Ghost Messaging systems and methods described herein can be used in a variety of applications and environments. For example, systems and methods could be employed within enterprise communications systems. As another example, systems and methods could be employed within industrial environments. As another example, systems and methods could be employed in the context of wide area deployments, such as, e.g., through an appropriate branding program (e.g., ATM, VISA, etc.).

Exemplary Embodiments

In the preferred embodiments, Ghost Messaging is a flexible information relevance management system. Preferably, information can be assigned certain relevance attributes such as “location” and “lifetimes.” Among other things, this allows messages to be routed to particular locations in combination with specific usernames and provides a mechanism for removing outdated information that has outlived its relevance.

In some preferred embodiments, further to the above discussion, a Ghost Messaging system architecture includes the functional entities shown in FIG. 1. In this regard, the functional entities preferably include:
1) Central Server (CS) 10 that preferably maintains the intelligence of the system, manages buddy lists, maps Bluetooth Device Addresses to Usernames and maps locations to BDADDRs (e.g., BDDADDRs include device addresses) of the Bluetooth Access Points.
2) Bluetooth Access Points (BAPs) 13 that preferably radiate Bluetooth signal and perform periodic scanning in order to determine the presence of Bluetooth devices within its coverage area (such as, e.g., roughly an area having a diameter of about 30-100 feet in some illustrative examples). In the preferred embodiments, the BAPs interface with client software and provide indications of the strength of client associations with that particular BAP by way of exchanging signal strength information. Preferably, BAPs are mapped to common location names via their BDADDRs; therefore, a client device 14 that is associated with a particular BDADDR can preferably find out what location it is in.
3) ReachMe Client Application RM that is a specific client application that is run on the client device 14 that organizes, parses, and displays information received from the BAPs and the Central Server. In some preferred embodiments, the ReachMe client application has a subcomponent called the Ghost Message Composition Center (GMCC) that allows Ghost Messages to be composed and delivery options to be expressed. In some preferred embodiments, there is also a Web-based Ghost Message Composition Center (such as, e.g., a password protected Web Site) that provides an appropriate Graphical User Interface via which authorized users with Web access can compose Ghost Messages and set delivery options with the Web-based system.
4) Backbone Network 12 that interconnects BAPs and the Central Server.

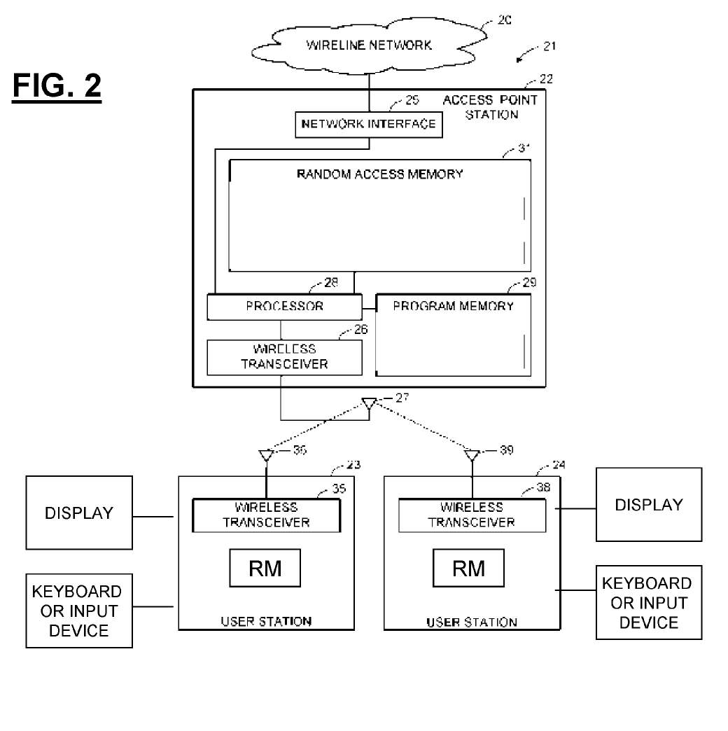

With reference to FIG. 2, in some illustrative and non-limiting embodiments, the access points and client devices can include some of the features shown in FIG. 2. In this regard, FIG. 2 shows an illustrative wireline network 20 connected to a wireless local area network (WLAN) generally designated 21. The WLAN 21 includes an access point (AP) 22 (such as, e.g., a BAP 13 as discussed above) and a number of user stations 23, 24 (such as, e.g., client devices 14 as discussed above). For example, the wireline network 20 can include the Internet or a corporate data processing network. For example, the access point 22 can be a wireless router, and the user stations 23, 24 can be, e.g., portable computers, personal desk-top computers, PDAs, portable voice-over-IP telephones and/or other devices. The access point 22 has a network interface 25 linked to the wireline network 21, and a wireless transceiver in communication with the user stations 23, 24. For example, the wireless transceiver 26 can include an antenna 27 for radio or microwave frequency communication with the user stations 23, 25. The access point 22 also has a processor 28, a program memory 29, and a random access memory 31. The user station 23 has a wireless transceiver 35 including an antenna 36 for communication with the access point station 22. In a similar fashion, the user station 24 has a wireless transceiver 38 and an antenna 39 for communication to the access point 22.

In some illustrative examples, BAPs 13 are deployed throughout an enterprise or the like and their coverage area demarcates a “location,” such as, e.g., the library, the Cafe, the lobby, the restaurant, the office, etc. In the preferred embodiments, the BAPs 13 continually scan for new client devices 14 within their areas. When a new device 14 is detected, the BAP 13 and the client device 14 preferably exchange signal strength information to determine the strength of the connection.

Client devices 14 within range of a BAP are associated with that location. Preferably, if a client device 14 is within the range of one or more BAPs 13, the client device is associated with a certain one of the BAPs. For example, in some preferred embodiments, it is associated with the BAP with whom it enjoys the best signal characteristics (such as, e.g., the strongest received signal strength). Therefore, even though a client device 14 may be near several different “locations,” it will preferably associate only with one of them at a time. Preferably, the user can explicitly change their association manually, if they wish. As part of the client application, the client device is preferably configured to: keep a buddy list (e.g., which may include a list of potential users of client devices 14 that are identified as “buddies” of that user; in this disclosure, the terminology “buddy” encompasses any relationship or correspondence between users); keep information identifying all the available locations and the signal strengths received from each of the nearby BAPs; to keep information related to locations of an availability of users (e.g., of buddies); and/or to keep other information.

The Central Server 10 preferably stores and maintains all information regarding each user's locations and status. Preferably, the Central Server also contains all the Ghost Messages that have been submitted to the system. Preferably, upon learning of either the creation of a new Ghost Message or the change in the status of the current users of client devices 14 in the system, such as the logging on of a new user, or a user changing location associations, the Central Server 10 will determine if any of the Ghost Messages have deliverability criteria that are satisfied. If so, those Ghost Messages are preferably delivered to the appropriate recipients.

The Central Server 10 also preferably maintains a list of all users (i.e., all users of client devices 14) and their buddy lists and provides updates to clients when their buddy's status changes. Furthermore, locations are preferably represented in the buddy lists; preferably, locations are given different icons to denote different status levels. For instance, the user will be presented with all the current locations that are on-line, the current location that it is associated with will be distinguished from all the other locations by the use of a unique icon.

Using this architecture, clients are preferably able to maintain buddy lists that indicate the presence, status, and location of their buddies that are currently online. When buddies move into new areas, this change is preferably reflected in the buddy list. Furthermore, a user of a client device 14 can preferably initiate a real-time chat session with any of its buddies that are currently active and available, regardless of their location. That is, the conditions of real-time chat only include the availability of the intended recipient.

A notable novelty of this system is the ability to send and receive Ghost Messages. Preferably, Ghost Messages can be directed to: specific locations (e.g., to all users of client devices 14 that are within a particular location, that enter a particular location or the like); groups of locations (e.g., plural locations concurrently); and/or to specified username recipients. A Ghost Message can preferably be created either on the client device 14 itself (such as, e.g., using a common alphanumeric keyboard and/or any other appropriate user interface) and/or via a Web-based or Internet-based application. In this manner, in preferred embodiments, Ghost Messaging subscribers and anyone with access to the Web-based resource can send Ghost Messages.

In the preferred embodiments, Ghost Messages have a number of unique characteristics. First, they allow a specific location to be expressed as a delivery option. Second, they allow the application of a temporal relevance to a message; for example, in some embodiments, a sender can indicate (e.g., input or select) a temporal relevance of the message. Preferably, the temporal relevance is a lifetime value for which the message is considered relevant. Past this time period, the message is preferably considered outdated and is discarded. For example, a Ghost Message that tells meeting participants that a meeting will take place on Tuesday at 9:00 a.m. can be given a lifetime value equal to Tuesday at 9:00 a.m. that the message is never propagated after the meeting has taken place. This helps to eliminate cases in which users are besieged by irrelevant information. It also makes the service more efficient because the service is not using network resources to transmit outdated information. In various embodiments, an appropriate temporal relevance can be employed. For example, such a temporal relevance can include an identification of any appropriate time or time interval (such as, in some illustrative examples: a) after date/time t1; b) between date/time t2 and t3; and c) before date/time t4).

Preferably, the location relevance is expressed as a delivery condition in the creation of Ghost Messages. That is, in some illustrative embodiments, a sender can specify that a Ghost Message is valid only at a Library location, or at all places except the library, for example. In addition, the sender can preferably also specify intended recipients of the Ghost Message, including logical operands such as, for example, ALL (e.g., send to all users at the location) and NOT (e.g., sent to all users except those specified). Preferably, intended recipients are in the form of system-recognized usernames.

In some embodiments, Ghost Messages have three criteria for deliverability. First, an intended recipient(s) field must be satisfied. Second, an intended location(s) field must be satisfied. Third, a temporal relevance of a Ghost Message should not have been exceeded. When client devices 14 enter new areas, they preferably contact the Central Server 10 and provide their new updated information. That is, they preferably inform the Central Server which location they are at and what their username is. Preferably, the Central Server then checks this username and location against all the Ghost Messages it has currently stored, checking for acceptable deliverability criteria. If a Ghost Message exists that meets all three deliverability criteria, that message is preferably sent to the client device. For example, in some preferred embodiments, the Ghost Message is caused to appear as a Pop-Up, HTML capable window on a display screen of the client device 14.

In the preferred embodiments, Ghost Messaging allows two forms of messaging to take place.
1) Traditional chat messaging: This is parallel to the traditional Instant Messaging functionality widely deployed today where users establish buddy lists and are given indications as to the availability of their buddies. They are then capable of exchanging messages in a real-time fashion with their currently available buddies.
2) Ghost Messaging: Ghost Messages are preferably a specific class of messages whose delivery options are specified by the sender, and whose ultimate delivery is conditioned on the receiver.
a. Preferably, Ghost Messages are directed to one or more locations by the sender (called intended locations), meaning that a message can be made relevant, by way of example, for a Library and not for the Main Entrance, or the like.
b. Preferably, Ghost Messages do not require the intended locations to be available, or operating, at the time of composition of the Ghost Messages.
c. Preferably, Ghost Messages can be addressed to one or more recipients (called intended recipients) by the sender.
d. Preferably, Ghost Messages do not require the intended recipients to be available at the time of composition, as in Instant Messaging.
e. Preferably, Ghost Messages are given lifetimes that establish the temporal relevance of the message by the sender. If a message lifetime expires, then the message is preferably discarded from the system.
f. Preferably, the conditions that must be satisfied in order for a Ghost Message to be delivered are that an intended recipient is in an intended location for a particular Ghost Message that has not expired.
g. Preferably, delivery of Ghost Messages follows immediately after satisfaction of the deliverability conditions.
h. Preferably, Ghost Messages appear as Pop-Up windows on the user's client device 14. However, it is contemplated that any other appropriate form of display is appropriate. Preferably, however, the Ghost Messages are at least made known to the user, such as, e.g., by an audible alarm and/or visual identifier to enable timely receipt of such messages.
i. Preferably, a special class of Ghost Messages involves messages that are delivered to all users who enter a particular area for the first time, such as, e.g., “Welcome Messages.” In such cases, there is an additional condition for the delivery of a Welcome Message or the like that preferably must be satisfied. This condition is that the client device must not have received the same Welcome Message or the like before (or in an appropriately defined length of time).
j. Preferably, Ghost Messages are not immediately respondable. That is, a recipient preferably cannot immediately initiate a response from the Ghost Message window that appears on the recipient's screen. This is because Ghost Messages are not guaranteed to be delivered in an instantaneous fashion from the time of their creation. Since delivery, but not creation, is conditioned on the location of the recipient, there is no guarantee that the sender will be available to receive a reply. However, the recipient of a Ghost Message could check their buddy list to see if the sender is in fact available and then initiate a traditional chat session using the ReachMe client. Therefore, Ghost Messages themselves are preferably intended to be for one-way type communications—e.g., much like wireless Post-it notes. Nevertheless, in some embodiments, if the sender was in fact available at that time, the recipient could be enabled to send an immediate response.

To appreciate Ghost Messages, it is noted once a Ghost Message is sent, it can be conceptually thought to imperceptibly hover around the ether of their intended locations (i.e., like a ghost), waiting for an intended recipient to enter at which time they instantaneously appear and/or are otherwise delivered to a recipient's client device 14. Ghost Messages can also be conceptually thought of as wireless Post-It notes; however, Ghost Messages have the notable benefits of confidentiality and inconspicuousness. For example, typical office behavior in current times is for a colleague to leave a note on the door of another colleague when visiting their office and finding no one there. This physical note is conspicuous in that other people can see that it is there, even if they have no desire to read it. In such cases, there is nothing to present nosey office workers from reading the note other than etiquette and consideration. Ghost Messaging offers a similar, but more secure and private means to leave notes or messages to others.

Ghost Messaging also has some more practical uses. In the context of maintenance, a worker who finds a broken projector in a room can simply leave a Ghost Message addressed to the custodial staff informing them of the problem. The next member of a custodial staff to enter that room and/or a member of the custodial staff that is presently within a certain location identified will be aware that the projector is broken. As another example, a person who finds the projector broken can leave a Ghost Message addressed to ALL people who enter that room informing them of the situation. These examples help to demonstrate how Ghost Messaging can help to keep the information about the event where it is most relevant, and, notably, how Ghost Messaging can help to keep the information from spreading to places where it is not relevant.

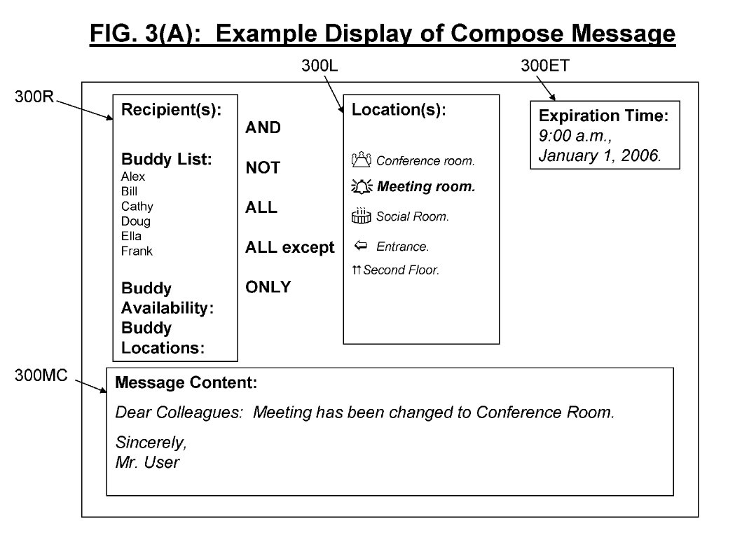

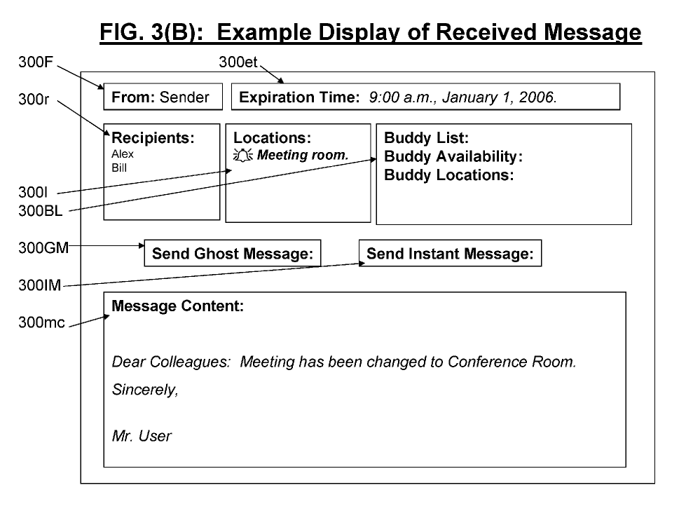

FIGS. 3(A) and 3(B) show some illustrative images (e.g., screen shots or windows) that can be presented to users in the composition of a ghost message (FIG. 3(A)) and in the receipt of a ghost message (FIG. 3(B)) according to some illustrative and non-limiting examples. In particular, FIG. 3(A) is an illustrative display image that can be presented to a user of a client device during the composition of a ghost message in some illustrative embodiments of the invention; and FIG. 3(B) is an illustrative display image that can be presented to a recipient user of a client device during the viewing of a received ghost message in some illustrative embodiments of the invention.

For example, as shown in FIG. 3(A), in the composition of a ghost message, a user can be presented with a graphical user interface (GUI) similar to that shown in FIG. 3(A). The GUI can include, e.g., a region 300R with which a user can click or otherwise activate functionality to identify or select one or more buddy from a buddy list (see, e.g., illustrative buddies listed in the illustrative example). In addition, the GUI can include, e.g., a region 300L with which a user can click or otherwise activate functionality to identify or select one or more location (see, e.g., illustrative locations listed in the illustrative example—along with illustrative location icons at a left side to facilitate reference to locations). In addition, the GUI can include, e.g., a region 300ET with which a user can click or otherwise activate functionality to identify or select an expiration time or another temporal identification. In addition, the GUI can include, e.g., a region 300MC in which a user can input textual information so as to generate a message to be delivered as a ghost message (see, e.g., the illustrative message shown in FIG. 3(A)). It is contemplated that any form of interface could be employed to facilitate user entry of text and/or selection of desired input values. In addition, FIG. 3(A) also shows some illustrative logical operands (i.e., AND, NOT, ALL, ALL EXCEPT, ONLY) that can be employed in some illustrative embodiments. In some illustrative embodiments, if a user clicks or otherwise selects one or more of these operands, the system can be configured so as to enable the recipient and/or location selections to be specially identified or selected based on such logical operands. As one example, a user could click the operand ALL EXCEPT and then click the recipient Bill so as to select all other recipients. As another example, a user could click the operand ONLY and then click the location Meeting Room so as to select delivery to only the Meeting Room (which is shown highlighted in the illustrative example). In addition, in some embodiments logical operands could be used as between the recipients and the locations. For example, in some embodiments, delivery could be based on conditions that identified recipients AND identified locations match (or in another example, to exclude delivery to certain recipients if those recipient are in a particular location).

It is also contemplated that in some embodiments, messages could potentially generate ghost messages concurrently with other forms of messages, such as, e.g., Instant Messages or e-mail depending on circumstances. By way of example, in some embodiments, upon clicking send or the like (not shown in FIG. 3(A)), ghost messages could potentially be delivered based on locations and other information identified, while other forms of messages could be concurrently delivered to certain recipients identified.

With reference to FIG. 3(B), this figure shows an illustrative display image or screen shot that a recipient user can be presented with, which can also be in the form of a graphical user interface (GUI) in some embodiments. The GUI can include, e.g., a region 300F that shows information related to the sender (e.g., the sender's identity), a region 300et that shows information related to the temporal relevance of the message, a region 300r that shows information related to the listed recipients of the message, a region 300l that shows information related to the location relevance of the message and a region 300mc that shows the actual content of the message. While the ghost message content is textual in the illustrative embodiment, in various other embodiments, any other type of media or content can be transmitted (such as, e.g., voice, images, video, data, other content, etc.) and/or any combination of such media or content can be transmitted. In addition, in some illustrative embodiments, the GUI can include a region 300BL with which buddy list information for the recipient user can be displayed. In addition, in some illustrative embodiments, the GUI can include a region 300GM with which a user can click or otherwise activate functionality to initiate transmission of that recipient user's own ghost message. In addition, in some illustrative embodiments, the GUI can include a region 300IM with which a user can click or otherwise activate functionality to initiate transmission of that recipient user's own instant message. In addition, the GUI can include, e.g., a region 300L with which a user can click or otherwise activate functionality to identify or select one or more location (see, e.g., illustrative locations listed in the illustrative example (along with illustrative location icons at a left side to facilitate reference to locations).

Illustrative Protocol Formats

In the preferred embodiments, the Central Server 10 should store messages in such a way that they can be easily retrieved and directed to client devices 14 when they appear at certain locations. The Central Server then determines whether or not certain messages are available for delivery to specific client devices that appear. To facilitate this, messages are preferably presented to the Central Server in such a way that all their pertinent information is made readily available. In some preferred embodiments, message formats will include the message body itself, together with header information that describes the recipients, the lifetimes, and intended locations of the message. Using these fields, the Central Server is preferably configured to appropriately store and mark message files for retrieval.

Furthermore, the Central Server is preferably configured to determine client device location. In some preferred embodiments, a client device is known by their Login (e.g., username) and Bluetooth Device Address. Preferably, the client device's position is preferably made known to the Central Server via calculation and comparison of data reported by the BAPs from their scanning and capturing process. Preferably, the BAPs report a list of Bluetooth Device Addresses and the corresponding signal strengths for each address. Therefore, to correlate distances to specific user names, the Central Server preferably has access to a file that maps the Bluetooth Device Address to the user's Username. It is useful if these mappings are made upon Login of the user so that different users can use different Bluetooth devices. Multiple device addresses may be associated with a single user to allow for a second layer of information. For example, a user may have a Bluetooth address associated with their PALM PILOT PDA, as well as another Bluetooth address associated with the user's laptop computer.

In some preferred embodiments, a GhostMessage Compositon Proxy Server (CPS) is provided on a client device 14 that offers a front-end component that allows users to compose messages and to set delivery options. The front-end then preferably constructs an appropriate header for the Ghost Messages that captures the delivery options and appends the message body for delivery to the Central Server. Preferably, the Central Server then parses the message header and obtains information about the intended Locations, Recipients, Lifetimes, Expiration Options, and other delivery options associated with the message.

In some illustrative and non-limiting examples, protocol fields for a Ghost Message can be established as set forth below.
<TYPE, Action, ID, Recipients, Sender, Locations, STARTTIME, Lifetime, Expiration, opt: message body> where:
(bracketed lists are now delimited by ;)
1) TYPE is a string identifying the type of message and will be GM for Ghost Messages. Other types are also possible.
2) ACTION is a string identifying the requested action for the message. Acceptable types are
   a. SEND—tells system that the message is meant to be left for delivery
   b. REVOKE—Tells system that the message referenced by the ID field needs to be removed from the system
   c. MODIFY—Tells the system that the message referenced by the ID field needs to be replaced with the present message
3) RECIPIENTS is a string or group of strings that specify the intended recipients of the message. Groups of recipients can be specified by using left and right brackets as delimiters. The RECIPIENTS field is composed of a logical indicator followed by a bracketed list of usernames:
   a. FUNCTION [username1; username2; . . . ; username n]
   b. FUNCTION can be either ALL, ALL EXCEPT, and USERS
   c. For example;
      i. ALL is a valid RECIPIENTS field that will allow all users in the area to receive this message
      ii. ALL EXCEPT [Dave; Mike] will allow all users but mike and dave to receive the message
      iii. ONLY [Dave; mike; Joe; Tony] will allow only users Dave, Mike, Joe, and Tony to receive the message
      iv. ONLY [dave] will allow only user dave to receive the message
4) SENDER is a string field that represents the username of the person who originated the message
5) LOCATIONS is a string or group of strings that specify the intended locations where the message is relevant. Groups of locations can be specified by using left and right brackets as delimiters. The LOCATIONS field is composed of a logical indicator followed by a bracketed list of well-understood Location names:
   a. FUNCTION [location1; location2; . . . ; location n]
   b. FUNCTION can be either ALL, ALL EXCEPT, and ONLY
   c. For example;
      i. ALL is a valid LOCATIONS field that will make the message relevant in all locations in the system.
      ii. ALL EXCEPT [Library; Main Entrance] will make the message relevant in all locations except the ones specified in the list, namely the Library and the Main Entrance
      iii. ONLY [Café; 1 G-239B; Meeting Room] will make the message relevant only in the specified places, namely the Café, room 1G-239B, and the Meeting Room.
6) STARTTIME is a formatted date object used to represent the time at which the message should be delivered. It has two options:
   a. NOW
   b. <MM>/<DD>/<YYYY>@HH:MM
7) LIFETIME is an integer representing the number of minutes that the CS should process the message after it begins processing (STARTTIME). Once the LIFETIME value has been reached the message is deleted from the CS
   a. A LIFETIME value of −1 represents an infinite lifetime.
   b. It's suggested that options for traditional times are made to the user, for instance they have pre-defined options for 1 Hour, 1 Day, 1 Week, etc. Then, these are translated into the appropriate number of minutes.
8) EXPIRATION is an integer that will represent one of 3 possible methodologies (for now, others may be added later) for removing messages after they have been received.
   a. A value of 1 will represent that the message should be removed when its LIFETIME value expires. This should be the default.
   b. A value of 2 will represent that the message should be removed after ALL of the intended recipients have been given the message.
   c. A value of 3 will represent that the message should be removed after ANY of the intended recipients have been given the message.
9) ID is an integer field that is used to identify and reference messages that are already in the Central Server. This value is bound to that message and is generated by the Central Server after it stores a message. This value is used with the MODIFY and REVOKE options. This value will be set to −1 for all new incoming messages that the Central Server has not seen before.
10) Message Body is the body of the message and may contain html, etc. There needs to be an EOF indication to signify the end of the message. This field is optional for REVOKE messages.

a. Handling Message Storage and Access from the CS

In some preferred and non-limiting examples, GhostMessageDB (GMDB) is the name of a server responsible for responding to the Central Server's message Queries. Preferably, the Central Server will periodically check to see if there are new Ghost Messages to be delivered. The GMDB is responsible for maintaining the Ghost Messages and responding to these requests from the Central Server.

In some embodiments, the GMDB implements the following:

```
CheckForNewMessages(CurrentTime, Location)
    Returns: list of MessageIDs and UserIDs
SentMessage(UserID, MessageID)
GetMessagesForUser(UserID, Location)
    Returns: list of MessageIDs
PurgeExpiredMessages(CurrentTime)
    Returns: list of expired MessageIDs
```

In some preferred embodiments, the Central Server contains a thread that runs at a regular interval (and sleeps for the excess time). It is assumed that message clean-up will not exceed the regular interval, and that the finest message granularity will be the size of that interval. In some illustrative examples, a five minute interval can be employed. In some illustrative embodiments, a thread can be implemented in accordance with the following paragraph.

CS Thread “Poller”: This thread will fire a call to CheckForNewMessages(current Time, Location) every alert interval (default of 5 minutes). The thread will call a PurgeExpiredMessages method on the GhostMessageDB (GMDB) to remove old messageIDs from the DB table, and to instruct the Central Server to remove its local copies of the corresponding Messages. The GMDB will fetch the list of UserIDs and MessageIDs to be delivered at this time and for this specific location. The reply from the Database (DB) to the Central Server will be a list of message Ids and user names. After each message is successfully sent by the Central Server, a SentMessage will be sent from the Central Server to the GMDB such that the GMDB can remove that user from the list of addressed recipients awaiting receipt of that particular message.

In some embodiments, the GMDB can be implemented in any number of ways. Preferably, the GMDB is transparent to the Central Server. Some example implementations are detailed below.

b. File Directory Approach

In some embodiments, this type of implementation exploits the different logical locations of files to distinguish which users at which locations are entitled to which messages. The Central Server preferably creates logical directories for each of the locations it services and stores copies of the relevant messages as files within those directories. In this fashion, many identical copies of the same message may exist in different folders. For instance, a message that is relevant at all locations would have a representative file in each of the location directories.

Each of these location directories contains a special file called a “Users File.” The Users file contains a list of known Usernames next to a list of the current filenames that contain messages relevant to that user. When a Central Server begins the procedure of locating relevant messages for users, it will open the Users file in the location directory corresponding to the Users current location. The Users File will then be parsed by the Central Server to determine the file names, within that directory, that should be sent to that user. This accomplishes a crude routing function for messages. The Central Server would also be responsible for maintaining the correctness of the Users file. This is noteworthy as it only uses this file to determine relevant messages. An example Users File is shown below:

```
C:/CentralServer/MessagePool/Library/Users.txt
    ALL:  filename1, filename2,...,filenameN;
    Username1:  filename1, filename2,...,filenameN;
    Username2: filename1, filename2,...,filenameN;
    ˜Username1:  filename1, filename2,...,filenameN
    ˜Username2:  filename1, filename2,...,filenameN
```

Here, the file contains a direct mapping of Usernames to the names of files that contain relevant messages for those users. In some examples, the protocol for the Central Server (CS) to store Ghost Messages can include the following.
1) The message is composed and the front-end applies the appropriate header field.
2) The CS receives the message on its incoming socket.
3) The CS parses the header information from the message.
4) The CS generates a unique message ID for the message.
5) The CS determines all the locations where the message is relevant.
6) [Here is a decision point; this will take different paths depending upon the use of SQL (SQL is discussed later) or Simple File Folders.] The CS saves the entire message, including the header, in a file named GhostMessageXXXX.txt in the Current (i.e. C:/CentralServer/MessagePool/Current) directory. Where XXXX represents the message ID that was generated for the message. This can be arbitrarily long, depending on the number of current Ghost Messages in the system.
7) The CS creates an archived copy of the message by renaming it GhostMessageXXXX-YYYYYY.txt and saving it in an Archived directory. The YYYYYY value represents the current date the message was received in MonthDayYear notation. For example, Nov. 9, 2001 would be 110901.
   a. NB: This functionality of archiving messages is not critical, but something that can be helpful in a real world implementation.
8) The CS copies GhostMessageXXXX.txt into every location directory where it is relevant. The locations are determined by examining the parsed header field and implementing the appropriate logic. For example, if the LOCATIONS=ALL, then the file is copied into all the location directories; if LOCATIONS=ALL EXCEPT [X, Y, Z], then the file is copied into all but the X, Y, and Z directories; and so on.
9) The CS would then modify all the appropriate Users file to reflect the new entry.
   a. Messages with RECIPIENTS=ALL would have their filenames placed in the ALL row.
   b. Messages with the field RECIPIENTS=USERS [e.g., Mike, Dave, etc.] would have multiple instances of their filenames placed in the file—one in each row for each of the unique recipients.
   c. Messages with the field RECIPIENTS=ALL EXCEPT [e.g., Mike, Dave, Joe] would have their filenames placed in the ALL row as well as in the ˜Username rows corresponding to each username specified in the list.

i. As an example, if the filename of the above message was GhostMessage0001.txt and was relevant in the Library, the resulting User's File in the Library directory would look like this:

ii. C:/CentralServer/MessagePool/Library/Users.txt
ALL: GhostMessage0001.txt
˜Mike: GhostMessage0001.txt
˜Dave: GhostMessage0001.txt
˜Joe: GhostMessage0001.txt

10) This would complete the message storage phase of the Ghost Messaging system.
11) Now, when the Central Server received an indication that a user was in a certain area, it would start the message delivery phase of the system.
12) The Central Server receives the Username and the Location of the client terminal.
13) The Central Server then consults the Users file in the proper directory and parses all the filenames that are associated with rows marked with the particular Username, and the “ALL” value, while removing any entries that are also in the ˜Username row.
14) The CS would remove redundant filenames discovered from step 13.
15) The CS would then deliver those unique message files to the user.

C. SQL Implementation

If the SQL implementation option is carried out (NB: this option can provide some advantages), the protocol flow would follow the above list until item 6. At that point, the Central Server will have all the information of the message. At step 6, the method would then proceeds as follows.
6) The CS deposits message into the Ghost Messages table within the Ghost Message Pool database.
   a. With respect to the implementation, it is assumed that there will be orders of magnitude fewer distinct locations than there will be distinct usernames in the system. This means that implementing a table where usernames can be listed with the NOT operator (˜Dave, ˜Mike, etc.) is more useful than implementing the NOT operator for locations. In some embodiments, it may be advantageous to place each message in a row in the Ghost Messages table corresponding to each location where it is relevant. So, if a message is relevant everywhere but one place, it will have N−1 listings in the table, where N is the number of distinct locations.
7) It is assumed that the CS has an open connection to the appropriate SQL database where the Ghost Message Pool database is stored.
8) The algorithm for inserting messages into Ghost Message Table is preferably as follows in some implementations:
   a. The Ghost Message table is arranged with the following Column Headings: Location, Recipient, Filename, Date, ID, Lifetime, ID, and Expiration.
   b. The CS parser will strip the message header of each message and obtain a list of all the distinct location and distinct recipients, including the special location and recipients denoted by the ‘ALL’ identifier.
      i. For example, a message with (Location, Recipient) header equal to (ALL, ALL EXCEPT [Dave, Mike]) will have
         1. One distinct location=‘ALL’
         2. Three distinct recipients=‘ALL’, ‘˜Dave’, and ‘˜Mike’
      ii. As another example, a message with header equal to (ALL EXCEPT [Library], ALL) will have
         1. N−1 distinct Locations (equal to every location but the Library) where N is the total number of locations in the system
         2. One distinct recipient=‘ALL’
   c. For every Distinct Location x and Distinct Recipient y do:
      i. INSERT into [Ghost Messages] Values (Location x, Recipient y, filename, Lifetime, Date, ID, Expiration)
9) The complexity, in terms of number of rows that a single message can generate in the Ghost Messages table, is at worst (N−1)*R/2, where R is the number of distinct Usernames in the system (NB: it is assumed that one would use the NOT operator in cases where one wanted to specify a list of Usernames greater then half the total number of users—and thus the introduction of ½ above). In some embodiments, this could be enhanced by using distributed Ghost Messages tables—e.g., one for each distinct location. This may also facilitate scalability for large systems.
10) The CS would then issue an identical command to the Archives Table so that the message could be archived in some implementations.
11) This would complete the Message Storage component of the system.
12) When the CS receives the Username and Location of a particular client, it will begin the message delivery phase, which is described below.

13) The CS would then Select appropriate filenames, using the appropriate Usernames and Locations provided by the client, from the Ghost Messages table to determine the correct relevant messages to send to a particular user at a particular location. This can be accomplished using the SQL Select command below.

```
SELECT DISTINCT filename
FROM [Ghost Messages]
WHERE filename NOT IN
            (SELECT DISTINCT filename
              FROM [Ghost Messages]
        WHERE (Recipient IN (‘˜Username’)))) AND
(Location = ‘ALL’) AND (Recipient = ‘ALL’)
OR
          (filename NOT IN
            (SELECT DISTINCT filename
              FROM [Ghost Messages]
              WHERE Recipient IN (‘˜Username’)))) AND
(Location = ‘Location’) AND (Recipient = ‘Username’)
OR
(filename NOT IN
            (SELECT DISTINCT filename
              FROM [Ghost Messages]
              WHERE (Recipient IN (‘˜Username’)))) AND
(Location = ‘Location’) AND (Recipient = ‘ALL’)
OR
        (Location = ‘ALL’) AND (Recipient = ‘Username’)
```

This is the final SQL algorithm that will return all the messages that are pertinent to a particular Username at a particular Location given the Protocol fields and table population methodology discussed above. Logically, this algorithm is equivalent to (A∩B∪C)∪(A∩D∩E)∪(A∩D∩C)∪(B∩E). Where, the events A, B, C, D, and E are as below:
1) A is the event that the associated filename of the message does not have an associated RECIPIENT field equal to “˜Username”.
   a. Meaning that the message is not explicitly forbidden for that user.
2) B is the event that the LOCATION field is equal to “ALL”.
3) C is the event that the RECIPIENT field is equal to “ALL”.
4) D is the event that the LOCATIONS field is equal to “Location”.
5) E is the event that the RECIPIENT field is equal to “Username”.

The first part of the algorithm ensures that the messages that are intended for ALL locations and ALL users, and are not explicitly forbidden for Username (by use of the ALL EXCEPT [Username] field), are directed to Username at Location. The second part of the algorithm ensures that messages intended for Location and addressed to Username, and are not explicitly forbidden for Username (this is actually redundant because event A really just prunes the table of all filenames that are explicitly forbidden from Username, and this level of protection isn't required when looking for messages explicitly INTENDED for Username, so this part of the algorithm can be decomposed to D∩C) are directed to Username at Location. The third part of the algorithm ensures that all messages addressed to Location and ALL users, and are not explicitly forbidden for Username are delivered to Username at Location. The final part of the algorithm ensures that all messages intended for ALL locations and Username are delivered to Username at Location.

c. Removing Messages from the System

In the preferred implementations, the Ghost Message system will need to be able to maintain lifetime counters and be able to remove messages that have outlived their temporal relevance or those that had completed their expiration options.

Therefore, in some embodiments, a RemoveMessage method will be employed that will clear all entries in the Ghost Messages table associated with the filename (or Message ID) of the message that is to be deleted. This method could look like this in SQL notation: DELETE FROM [Ghost Messages] WHERE filename=‘filename’. This one SQL command will remove multiple rows from the table and needs to be issued only once.

The Central Server should also be able to maintain message timers to keep track of when messages should be deleted from the server.

d. Notifications

The system should preferably be aware of when a new message is entered into the system. In some embodiments, this indication can be given by establishing an appropriate trigger in the Ghost Messages table. Preferably, a new message always results in the creation of at least one new row to the Ghost Messages table. Therefore, a trigger that will provide the central server with an indication whenever a new row is added to the Ghost Messages table is a good time to check to see if the any of the relevant clients are in relevant areas to receive this message. This can be effected in a variety of ways—a goal being to deliver a Ghost Message (not an Instant Message, though the procedure may be similar in some examples) to clients that are already in a relevant area. Notably, the Central Server should store a current mapping of clients to areas and should readily be able to push the message to the relevant clients whenever it is received.

In addition, the CS needs to know when certain messages have been delivered to clients so that it can implement the expiration options functionality. So, the CS preferably is configured to know and track who has already received what messages. In some examples, this can take the form of another table, such as a Ghost Messages Delivered Table, that is consulted and modified upon delivery events. The CS could then check this table against the expiration options of certain messages to decide when to remove certain messages.

Broad Scope of the Invention

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example” and “NB” which means “note well.”

What is claimed is:

1. A messaging system, comprising:
a) a server configured to receive location information related to client devices from a plurality of access points;
b) said server being configured to receive ghost composed by users of client devices that include indications of location relevance; and
c) said server being configured to store user information data, data related to said location information of client devices and data related to said messages composed by client devices.

2. The messaging system of claim 2, wherein said system is configured to require the satisfaction of the following three criteria for delivery of one of said messages: an intended recipients field must be satisfied; an intended locations field must be satisfied; and a temporal relevance field must be satisfied.

3. A ghost messaging system, comprising:
a) a server configured to store user information, location information of client devices and ghost messages composed by users of client devices;
b) a plurality of access points configured to transmit location information related to client devices to said server; and
c) at least one client device configured to compose ghost messages, including indications of location relevance.

4. The ghost messaging system of claim 3, further including said plurality of access points being distributed throughout a vicinity and having coverage areas demarcating locations within said vicinity.

5. The ghost messaging system of claim 3, further including said system being configured to associate a client device within a coverage area of one of said access points with said one of said access points.

6. The ghost messaging system of claim 5, wherein said system is configured to associate a client device within a range of a plurality of access points with an access point to which the client device has better signal characteristics.

7. The ghost messaging system of claim 3, wherein said server is configured to store user buddy lists along with locations of buddies that are currently online.

8. The ghost messaging system of claim 3, wherein said system is configured to enable said client devices to display a user buddy list that includes the presence, status and location of buddies that are currently online.

9. The ghost messaging system of claim 3, wherein said system is further configured to enable a user to initiate a real-time chat session with at least one of the user's buddies that are currently active and available.

10. The ghost messaging system of claim 3, wherein said system is configured to receive ghost messages from client devices, said ghost messages being structured to be specifically directed to one or more of the following: specified locations; specified groups of locations; and specified recipients.

11. The ghost messaging system of claim 3, further including said system being adapted to provide a Web-based user interface through which ghost messaging subscribers can send ghost messages.

12. The ghost messaging system of claim 3, wherein said system is configured to enable a user to select certain locations from a set of locations based on logical operands.

13. The ghost messaging system of claim 12, wherein said logical operands include ALL, NOT or ALL EXCEPT operands.

14. The ghost messaging system of claim 3, wherein said system is configured to enable a user to specify a specific location as a delivery option.

15. The ghost messaging system of claim 14, wherein said system is configured to enable a user to specify a temporal relevance to the message.

16. The ghost messaging system of claim 15, wherein said temporal relevance is a lifetime value for which the message is relevant.

17. The ghost messaging system of claim 3, wherein said system is configured to require the satisfaction of the following three criteria for delivery of a ghost message: an intended recipients field must be satisfied; an intended locations field must be satisfied; and a temporal relevance field must be satisfied.

18. The ghost messaging system of claim 3, further including said system being configured to present ghost messages via a client device by an automatic display and/or alarm.

19. The ghost messaging system of claim 3, further including said system being configured to present ghost messages via a client device as pop-up windows on a display of said client device.

20. The ghost messaging system of claim 3, wherein the system is configured to enable a user to send certain messages to a recipient only if the recipient has not yet received that message.

21. The ghost messaging system of claim 3, wherein said system is configured such that a recipient of a ghost message cannot immediately initiate a response from a ghost message window that appears on a recipient's display.

22. A method of managing distribution of an electronic message from a sender to a recipient, comprising:
a) receiving an electronic message from a client device operated by a user which electronic message includes an identification of at least one location for delivery of said message; and
b) delivering said electronic message to at least one recipient within said identified at least one location based on said identification of said at least one location.

23. The method of claim 22, further including receiving said electronic message with an identification of a temporal relevance of said electronic message, and only delivering said electronic message to said at least one recipient within said at least one identified location during a relevant time period based on said identification of temporal relevance.

24. The method of claim 23, further including receiving said electronic message with an identification of at least one intended recipient for delivery of said message.

25. The method of claim 24, wherein said at least one recipient within said at least one identified location consists of at least one of said at least one intended recipient, and including only delivering said message to said at least one of said at least one intended recipient in the event that said at least one of said at least one intended recipient is within said location during said relevant time period.

26. The method of claim 22, wherein said message includes at least one type of media from the group consisting of text, voice, image, video and data media.
